(19) United States
(12) Patent Application Publication
(10) Pub. No.: US 2015/0206377 A1
(43) Pub. Date: Jul. 23, 2015

(54) LOTTERY

(71) Applicant: LMS PATENTS (ISLE OF MAN) LIMITED, Douglas (IM)

(72) Inventors: John Anthony Reid, Auckland (NZ); James William Piper, Auckland (NZ)

(21) Appl. No.: 14/421,250

(22) PCT Filed: Aug. 9, 2013
(86) PCT No.: PCT/IB2013/056505

§ 371 Date: Feb. 12, 2015

(30) Foreign Application Priority Data
Aug. 15, 2012 (NZ) 601824
Sep. 20, 2012 (NZ) 602537
Oct. 17, 2012 (NZ) 603063
Nov. 16, 2012 (NZ) 603674
Apr. 10, 2013 (NZ) 609252

(51) Int. Cl. G07F 17/32

(52) U.S. Cl. CPC G07F 17/329; G07F 17/3244

(57) ABSTRACT

This invention relates to a method of conducting a gaming system such as a lottery. The invention provides a computer system for recording entries to a game and determining one or more winners of the game. The game has an entry fee and is conducted in at least a first phase and a final phase, the first phase consisting of one or more games from which the number of entries in the or each first phase game is or are reduced substantially so that the number of entries which progress from the first phase game or games to the final phase is substantially less than the number of entries in the first phase game or games. The entries in the final phase which have progressed from the one or more first phase games to the final phase are entered into a final game, which final game includes a final prize which may or may not be won. The entry fee for all first phase entries includes an amount which is allocated to be set aside and or used to fund or to purchase insurance against the winning of the final prize.

### FIELD OF THE INVENTION

A Lottery with a Substantial Additional Prize—Insurance or Self Insurance

This invention relates to a two stage or two phase game or gaming system that involves a series of first phase games followed by a second phase or Super Game.

### BACKGROUND

Gaming operators will frequently wish to offer significant prizes as an attraction to potential participants. However if these prizes are available in each draw then it is an obvious pre-requisite that a large number of entries must be sold. Particularly in the early stages of a game this cannot be guaranteed and the game could fail as insufficient entries are sold. One solution is to make the significant prize difficult to win and not guaranteed. This enables a prize pool to be set up so that this pool has sufficient funds to pay out the significant prize when it is won. However this has disadvantages if the significant prize is won early on in the cycle of games.

A further alternative is to build up the prize pool before offering the significant prize but this has the disadvantage that the initial impact of the game is reduced and the return to participants is artificially reduced during the build up process.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications may be referred to herein; this reference does not constitute an admission that any of these documents form part of the common general knowledge in the art, in New Zealand or in any other country.

### DEFINITIONS

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is therefore an object of the present invention to obviate or minimise the foregoing disadvantages in a simple yet effective manner or at least to provide the public with a useful choice.

Accordingly in one aspect the invention consists in a method of conducting a gaming system having a computer system for recording entries to a game and determining one or more winners of the game, in which the game has an entry fee and is conducted in at least a first phase and a final phase, the first phase consisting of one or more games from which the number of entries in the or each first phase game is or are reduced substantially so that the number of entries which progress from the first phase game or games to the final phase is substantially less than the number of entries in the first phase game or games, the entries in the final phase which have progressed from the one or more first phase games to the final phase being entered into a final game, which final game includes a final prize which may or may not be won, the entry fee for all first phase entries including an amount which is used to fund or to purchase insurance against the winning of the final prize.

Preferably the only way a participant can obtain entry to the final phase game is by entry into the first phase game and becoming one of the entries to progress to the final phase of the game.
Preferably the number of entries which progress from the or each first phase to the final phase is less than 30% of the entries to the first phase game or games.
Preferably the number of entries which progress from the or each first phase to the final phase is less than 10% of the entries to the first phase game or games.
Preferably the number of entries which progress from the or each first phase to the final phase is less than 5% of the entries to the first phase game or games.
Preferably the number of entries which progress from the or each first phase to the final phase is less than 1% of the entries to the first phase game or games.
Preferably the game includes one or more intermediate phases between the first phase and the final phase, the number of entries being further reduced in the or each intermediate phase of the game.

Preferably the final phase also includes prizes which must be won.

Preferably the first phase includes prizes which may or which must be won.
In a further aspect the invention consists in a computerized gaming system having at least one computer system for recording entries to a game and determining one or more winners of the game, in which the game has an entry fee and is conducted in at least a first phase and a final phase, the first phase consisting of one or more games from which the number of entries in the or each first phase game is or are reduced substantially so that the number of entries which progress from the first phase game or games to the final phase is substantially less than the number of entries in the first phase game or games, the entries in the final phase which have progressed from the one or more first phase games to the final phase being entered into a final game, which final game includes a final prize which may or may not be won, the entry fee for all first phase entries including an amount which is used to fund or to purchase insurance against the winning of the final prize.
Preferably the only way a participant can obtain entry to the final phase game is by entry into the first phase game and becoming one of the entries to progress to the final phase of the game.
Preferably the number of entries which progress from the or each first phase to the final phase is less than 30% of the entries to the first phase game or games.
Preferably the number of entries which progress from the or each first phase to the final phase is less than 10% of the entries to the first phase game or games.
Preferably the number of entries which progress from the or each first phase to the final phase is less than 5% of the entries to the first phase game or games.
Preferably the number of entries which progress from the or each first phase to the final phase is less than 1% of the entries to the first phase game or games.
In a still further aspect the invention consists in a computerized game having at least one computer system for recording entries to a game and determining one or more winners of the game, in which the game has an entry fee and is conducted in at least a first phase and a final phase, the first phase consisting of one or more games from which the number of entries in the or each first phase game is or are reduced substantially so that the number of entries which progress from the first phase game or games to the final phase is substantially less than the number of entries in the first phase game or games, the entries in the final phase which have progressed from the one or more first phase games to the final phase being entered into a final game, which final game includes a final prize which may or may not be won, the entry fee for all first phase entries including an amount which is used to fund or to purchase insurance against the winning of the final prize.
Preferably the only way a participant can obtain entry to the final phase game is by entry into the first phase game and becoming one of the entries to progress to the final phase of the game.
Preferably the number of entries which progress from the or each first phase to the final phase is less than 30% of the entries to the first phase game or games.
Preferably the number of entries which progress from the or each first phase to the final phase is less than 10% of the entries to the first phase game or games.
Preferably the number of entries which progress from the or each first phase to the final phase is less than 5% of the entries to the first phase game or games.
Preferably the number of entries which progress from the or each first phase to the final phase is less than 1% of the entries to the first phase game or games.
In a still further aspect the invention consists in a two-phase game result determination system incorporating a computer system, the computer system including:
   one or more first game result determiners able to receive multiple entries to the game,
   a final game result determiner able to receive entries permitted by the first game result determiner to move from the or each first game determiner to the final game result determiner, and
   one or more entry fee recording means to record the entry fee paid for an entry to the first game result determiner,
   the first game result determiner or first game result determiners, on receipt of all entries in the game, permitting some entries to proceed to the final game result determiner,
   and optionally allocating a prize to at least some of the entries received by the or each first game result determiner;
   the second game result determiner, on receipt of the entries from the or each first game result determiner which proceed to the final game result determiner optionally allocating a prize to at least some of the entries which proceeded to the final game result determiner, and
   allocating a final prize, which may or may not be won, to one or more of the entries which proceeded to the final game result determiner, the entry fee for all entries recorded by the entry fee recording means being in part allocated to fund or purchase insurance against the winning of the final prize.
   Preferably the only way a entry can move to the final game result determiner is to be permitted by a first game result determiner to progress to the final game result determiner.
   Preferably the number of entries which progress from the or each first game result determiner to the final game result determiner is less than 30% of the entries to the first game result determiner or first game result determiners.
   Preferably the number of entries which progress from the or each first game result determiner to the final game result determiner is less than 10% of the entries to the first game result determiner or first game result determiners.
   Preferably the number of entries which progress from the or each first game result determiner to the final game result determiner is less than 5% of the entries to the first game result determiner or first game result determiners.
   Preferably the number of entries which progress from the or each first game result determiner to the final game result determiner is less than 1% of the entries to the first game result determiner or first game result determiners.

### DESCRIPTION OF THE DRAWINGS

FIG. 1 is a diagram of the electronic environment of the invention,

FIG. 2 is a block diagram of the functional elements of the invention,

FIG. 3a is table showing the odds of picking “r” numbers in order from a pool of numbers,

FIG. 3b is a calculation of odds useful in the invention showing permutations without repetition,

FIG. 3c is a table showing the odds of picking “r” numbers in any order, and

FIG. 3d is a calculation as in FIG. 3b relating to combinations without repetition.

### PREFERRED EMBODIMENTS OF THE INVENTION

The following description will describe the invention in relation to preferred embodiments of the invention, namely a Lottery with an insurance aspect. The invention is in no way limited to these preferred embodiments as they are purely to exemplify the invention only and that possible variations and modifications would be readily apparent without departing from the scope of the invention.

This invention provides a method by which a gaming operator offers a game having at least two stages phases to provide a means for the gaming operator to be able to offer one or more substantial ‘extra’ prizes that can be won in the final phase or final game hereinafter called the Super Game (as opposed to will be won), for a ‘relatively affordable cost’.

We set out a method and explain below why we say it is a ‘relatively affordable cost’ to the gaming operator.

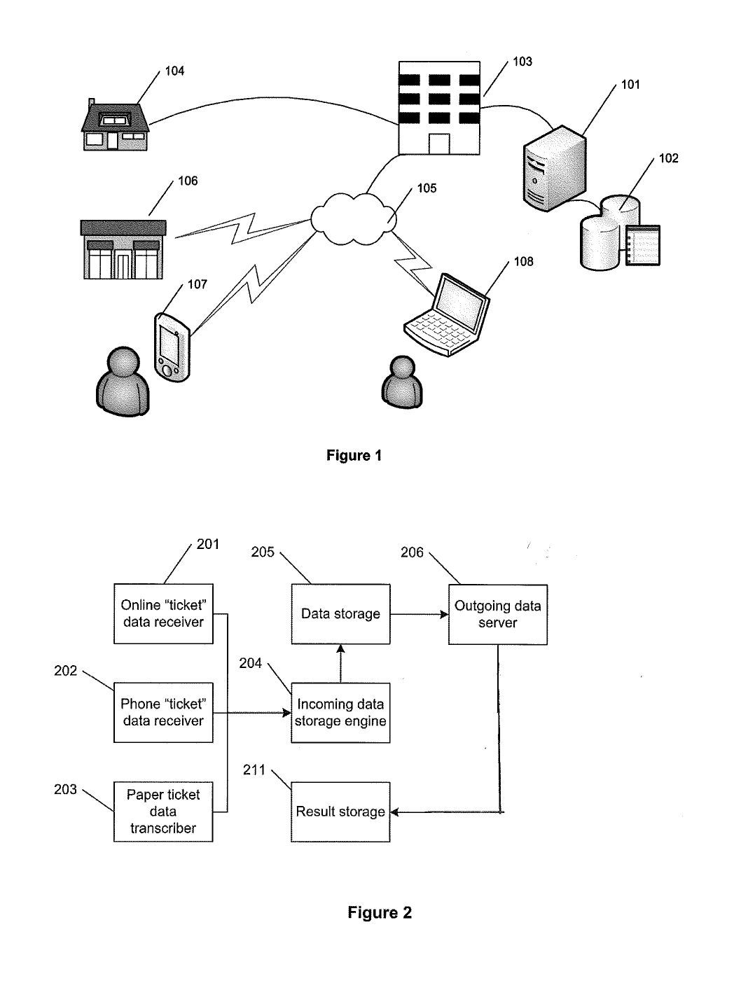

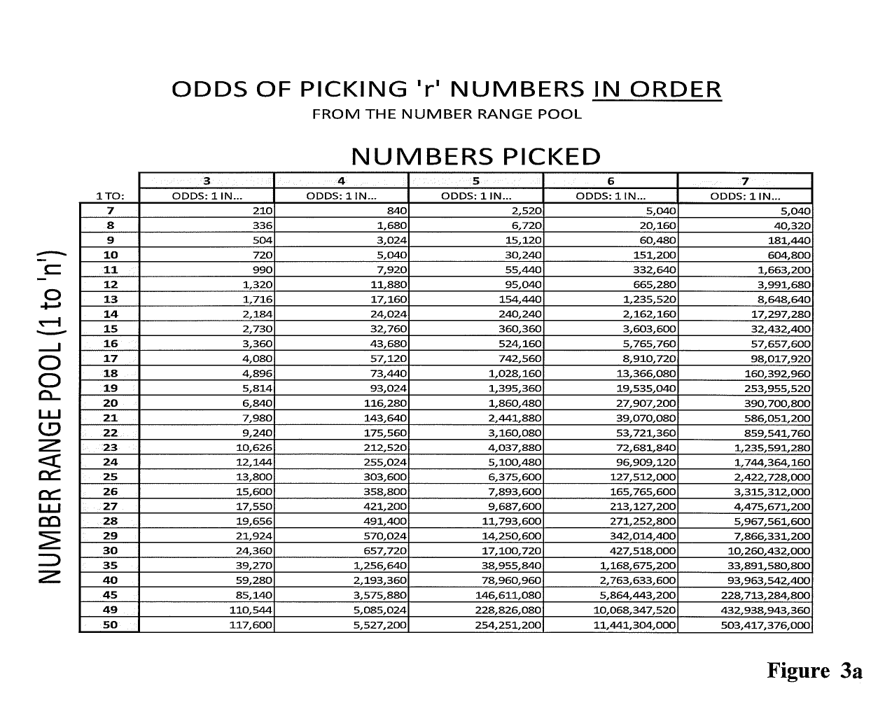

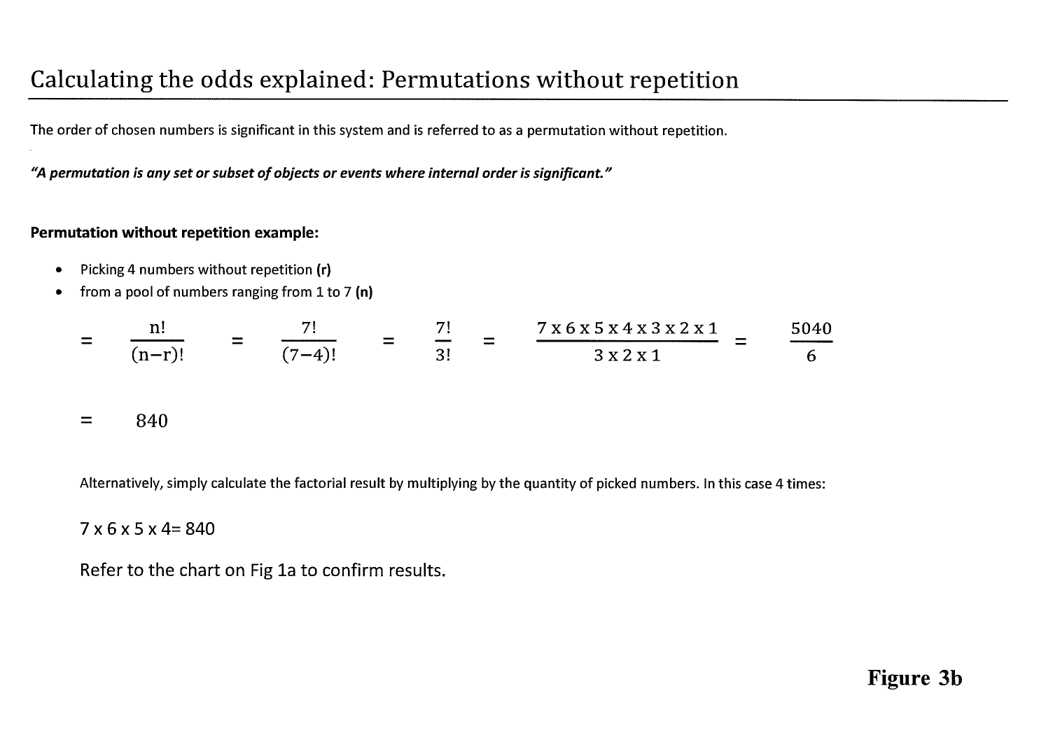

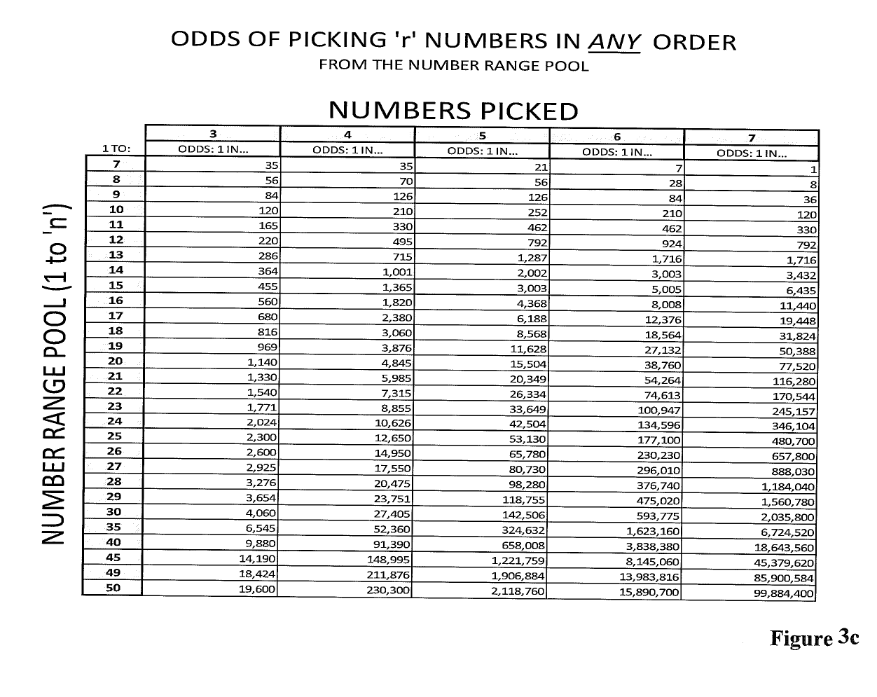

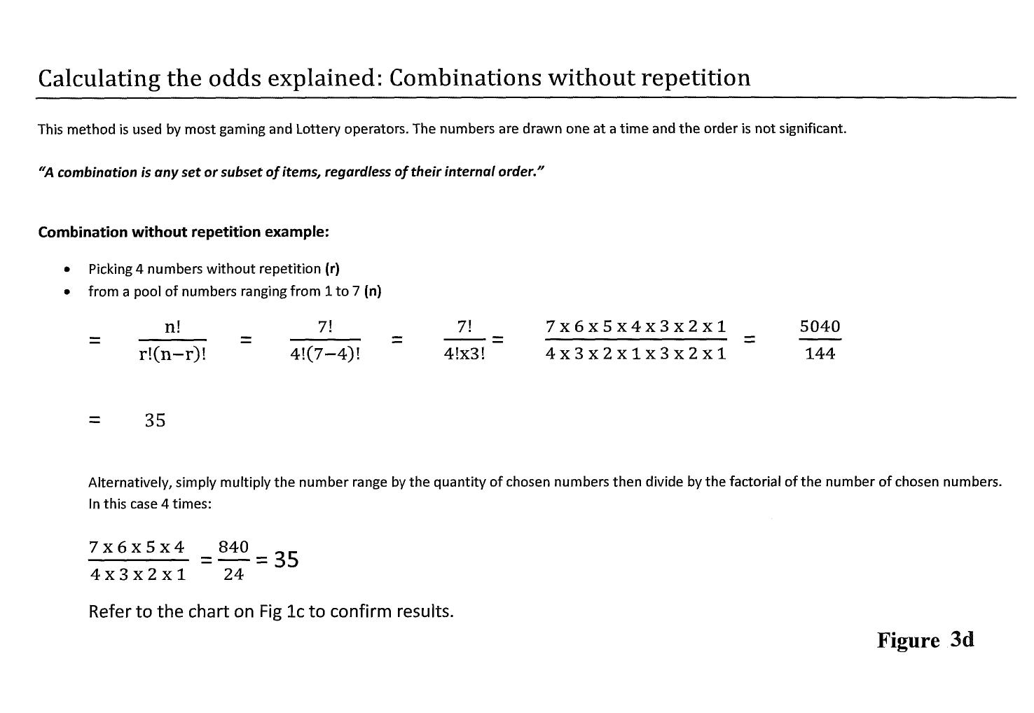

FIG. 1 shows a general environment of the invention where an organisation 103 has a server 101 storing a database 102 entries from such as a home resident 104 connected via telephone to a voice commended entry at the organisation 103. Telephone or internet connected entries can be received from a shop or machine kiosk 106, from mobile users 107 or from static users 108. In fact it is envisaged that any secure available method of receiving entries can be used.

FIG. 2 shows the progress of the ticket or entry details as they are purchased, where at 201 an online customer can enter data and purchase a ticket, including entering or selecting numbers or symbols for the lottery draw. Purchase data passes to a central location where an incoming data storage engine 204 passes the data to data storage 205.

In similar manner a phone customer 202 can select data for a ticket using a voice directed phone system before the information is passed to the storage engine. A customer buying a ticket at a retail establishment 203 can similarly choose their own symbols or numbers or accept a machine chosen set of symbols or numbers before completing a transaction which sends the chosen data to data storage.

Once the lottery closes the information in the data store can be frozen and at the draw time the data transferred through an outgoing data server at 206.

Once the final result of the games described herein after are known the results are stored in result storage 211, before being broadcast in whatever fashion desired such as via internet, television programmes or otherwise as desired.

Assume that:
a two phase game is offered by a gaming operator, involving a series of first phase games followed by a final phase including the Super Game;
each first phase game and the following final phase Super Game involves players having entries that contain in order 6 numbers out of 20;
a ticket into each first phase game costs $10, and entry into the final phase Super Game is only by qualification from a first phase game. It is intended that there is no further cost to the participant to enter the final phase;
a ‘substantial additional prize’ of $50 million is offered for the final phase game (i.e. for the Super Game)—to be paid as an additional prize if a qualifying entry into Super Game correctly contains in order the 6 winning numbers in Super Game;
the game is arranged so that the odds of succeeding in the Super game are very low. In the example the odds against an entry correctly containing in order the 6 winning numbers from 20, are odds of 1 in 27,907,200—see FIG. 1a;
the cost to insure a ‘substantial additional prize’ of $50 million, calculated on a qualifying entry in Super Draw and paid to an entry containing in order the 6 winning numbers, is an insurance premium of about two times the risk relative to that qualifying entry;
a premium of two times the risk means that the insurer wants to receive $100 million in premiums from 27,907,200 entries (paid as relevant entries are contracted into Super Draw) in exchange for insuring against the event for $50 million. In other words the insurer charging a premium of 2 times the risk expects that on average the insured amount of $50 million would go off once every 27,907,200 entries, and the insurer would have received $100 million in insurance premiums for this exposure;
the insurance premium cost to be paid by the gaming operator would therefore be approximately $3.58 per entry, or 35.8% of an original $10 entry fee. (Calculated at $3.58 per entry×27,907,200 entries=$100 million (rounded);

This insurance is expensive and would in most cases be cost prohibitive. Self insurance by a gaming operator can in one sense reduce the ‘insurance cost’ by up to half, provided events transpire in accordance with expected probabilities, but exposes the gaming operator to great risk in the event that the promised event occurs earlier than planned for, and/or more frequently than expected.

However, an advantage for the gaming operator and the players when using the two stage or two phase game (which we describe in more detail in Example 1 below) is that the gaming operator can offer such a ‘substantial additional prize’ of $50 million in the Super Game at a ‘relatively affordable cost’. This is explained below:
the $3.58 insurance cost applicable to each relevant entry, is a cost applicable to only those relevant or qualifying entries that make the Super Draw. In a two stage or two phase game, this cost can then be ‘spread’ against all the entries in all the first phase games, as each of those entries would have been made on the basis of attempting to gain entry into Super Draw so as to gain access to the opportunity to win the extra ‘substantial additional prize’ of $50 million.
Assume that from each first phase game, only 5% or 1/20^{th} of all first phase players qualify for the Super Game.
It then follows that the cost of providing this ‘substantial additional prize’, spread over all entries, would then be no more than $0.1792 per entry (and even less if self insured), being an amount easily absorbed within the costs of the overall game and thereby rendering the cost as a ‘relatively affordable cost’.

So while the cost to cover any ‘substantial additional prize’ of $50 million on a per relevant entry basis would be of itself high ($3.58, or 35.8% of the relevant entry fee originally paid by that $10 entry), when a two stage or two phase game operates as we describe herein, the cost can be spread over all the participants in the first phase games, And that cost then becomes low ($0.18, or 1.8% spread over each entry fee)—which is calculated on the basis that 5% of all entries can become eligible for Super Draw. The number of entries that can become eligible for Super Draw is a matter of choice but we believe that 30% or less is desirable. In fact less than 10% is desirable and we have selected about 5%. Lower figures such as less than 1% could be used but it should be borne in mind that the more entries that go through to the final phase the more likely it is that a winner of the additional prize will be found. This is because increasing the number of entries in the final phase the more likely it is that a winner will be found. Conversely having the number of entries in the final phase draw too low means that insufficient winners may be found over a period of time to maintain interest in the game.

This is more fully set out in the example below.

### Example 1

### Example 1.0

### A Series of First Phase Games, Followed by a Super Game—with a Large ‘Extra’ Prize—at a Relatively Affordable Cost

The following describes a game structure that involves a series of first phase games (in this example below we use 25), followed by a Super Game, where there is on offer in Super Game a large ‘extra’ prize that may be won, in addition to the ‘totalizer prizes’ that will be won.

The large ‘extra’ prize can be a prize underwritten by third party lottery insurance, or it can be self insured by the gaming operator. Either way, the cost of the insurance, or if the event is to be self insured by the gaming operator, operating prudently, the cost/amount needed to be set aside against the risk (hereafter “Extra Prize Cost”), is in relative terms to the number of players in the Super Game, an affordable cost. It is in relevant terms an affordable cost as the Extra Prize Cost is spread over all players in the first phase games, whether or not they obtain entry into the Super Game. We explain this concept further below in an example of its use.

### Example 1.1

### Assumed First Phase Game Profiles

In this example, it is assumed that:
There are 25 first phase games, all of which have the same game profile in terms of number of entries, cost, and profile of winners and eliminations. The conclusion of the 25 first phase games is followed by one Super Game;
Preferably, the gaming system used guarantees a winner in each first phase game and also in the following Super Game, of the totalizer (guaranteed) first prize on offer, irrespective of players choices on their entries; “example 1 herein describes a ranking system which can be used to guarantee either a winner or a small number of joint winners. This method is expanded on in co-pending Australian application 2013203606.
The 25 first phase games are played weekly, and are played each week by 500,000 players;
The first phase games and the Super Game have the same game number profiles—entries contain in order 6 numbers from a number range ‘n’ which in this example is 20.
In each first phase game, each player chooses, or each entry contains, in order, 6 different numbers from a range of 20 numbers and pays a total cost of $10 for an entry;
In each first phase game, the 20 numbers in the available number range are ranked to form a ranking list of the 20 numbers, from first to last. (Alternatively the ranking list could comprise a ranking of less than all of the 20 numbers, but must contain a sufficient number of the numbers ranked in an order to determine the desired results/winners for the game). Hereafter called the “Ranking List”.
In this example the Ranking List comprises the ranking of all the 20 numbers, from 1^{st} to last, and this is believed to be the best way to achieve the results of the game. The first number choices made by each player are used to determine the ranking list of the 20 numbers, using the ‘least chosen’ method—i.e. the ‘least’ chosen number of the 20 available numbers is ranked 1^{st} on the ranking list, the second least chosen number is ranked 2^{nd}, and so forth with the most chosen number being ranked last;
In this example, in respect of the 1^{st} first phase game, number [13] is the number that is chosen the least by all the 500,000 punters in the game as their first choice number, and therefore is ranked 1^{st} on the ranking list;
There are 19,500 players that have chosen number [13] as their first number choice in the 1^{st} first phase game;
Those 19,500 winning players each receive one bonus entry into the following weeks first phase game i.e. valued at $10 each ($195,000) and one entry into the Super Game.
Ties between any of the 20 numbers as a result of two or more numbers being chosen the same number of times by players are resolved—see Example 1.3 below.
The 19,500 winning players are subject to further eliminations using the results of those players other choices of numbers, compared with the Ranking List.
The total revenue from each first phase game is $5,000,000;
The available prize pool from each first phase game is 50% of total revenue;
Total prizes available from each first phase game are $2,500,000—of which 25% ($625,000) is set aside for the Super Game;
The Super Game is played in an identical fashion to the first phase games, with each qualifying entry containing in order 6 numbers out of 20. Preferably, the 6 number choices for the Super Game are randomly selected for the player and are provided to a player at the time the player enters into the first phase game and the Super Game entry numbers are linked by computer with the first phase entry. The Super Game entry numbers only become valid if the player's first phase entry attains entry into the Super Game. We believe that this is preferable because it is the most practical way currently known to us to ensure that there is a spread of chosen numbers in or at the Super Game level applying when the winner/s of the totalizer prize/s are being determined, and when obtaining insurance (or self insuring) the additional extra prize/s that may be won and which are referred to below.
Guaranteed Prizes: The ‘guaranteed’ available prize pool over all games (first phase and the associated Super Game) is 50% of total revenues. Total ‘guaranteed’ prizes available from each first phase game is therefore $2,500,000—from which one quarter ($625,000) is set aside to accumulate for the ‘guaranteed’ prizes in the Super Game. The balance of $1,875,000 is paid out to the winning players of the relevant first phase game.
Super Game will therefore have a ‘guaranteed’ prize pool of $15,625,000;
Extra $50 million Prize—Super Game Only: In addition to the ‘guaranteed’ prizes of $15,625,000 available in the Super Game, an additional extra prize of $50 million will be paid to a player in Super Game that has on his/her entry, in order, the 6 winning numbers in the Super Game—also see Example 1.10
The cost of these extra prizes is a cost borne by the gaming operator. This is calculated at 1.792% of ALL revenues and has been calculated by reference to the estimated cost of obtaining third party insurance, using a rate of 2 times the insured risk—also see Example 1.10.

### Player's Objective

Pick 6 different numbers from a range of [20] numbers, where each number picked is picked to progressively be the ‘least picked’ number, as picked by all the players in the relevant first phase game.

The ‘least picked’ first choice number will be placed or ranked first in the Ranking List. The second least picked first choice number will be ranked second, and so on.

A player's objective is at least twofold:

Firstly: to avoid initial elimination in a first phase game by correctly picking as his/her first number choice, the number that is to become ranked 1^{st} on the Ranking List—thereby winning a monetary prize and gaining entry into the Super Game (which has big ‘guaranteed’ prizes that will be won (i.e. $15,625,000), and an even bigger ‘extra’ prize of $50 million that may be won), and as a result of correctly picking the first number, the player remains eligible to continue in the first phase game and compete for its first prize;

Secondly: to avoid further eliminations in the first phase game by correctly picking as his/her;
second number choice, the number that is to become ranked 2^{nd} on the Ranking List, and
third number choice, the number that is to become ranked 3^{rd}, and so on.

Any failing by players to correctly chose a relevantly ranked number placement on the Ranking List is of no effect in respect of determining the winner of a first prize as the player/s with the next best choice/s ultimately becomes the winner of the first phase game's major prize.

TABLE 1
Example 1.2
Results of 1^{st} First Phase Game by 500,000
Players - One Data Set from the first number choices

| BY RANKINGS | | | BY NUMBERS | | |
|---|---|---|---|---|---|
| RANK- | | | | | RANK- |
| INGS | NUMBER | | | NUMBER | INGS |
| OF | OF | | | OF | OF |
| LEAST | TIMES | NUMBER | NUMBER | TIMES | LEAST |
| PICKED | CHOSEN | CHOSEN | CHOSEN | CHOSEN | PICKED |
| 1^{st} | 19,500 | 13 | 1 | 19,657 | 2^{nd} |
| 2^{nd} | 19,657 | 1 | 2 | 27,000 | 13^{th} |
| 3^{rd} | 20,560 | 19 | 3 | 21,974 | 7^{th} |
| 4^{th} | 20,988 | 9 | 4 | 25,000 | 10^{th} |
| 5^{th} | 21,344 | 7 | 5 | 29,333 | 19^{th} |
| 6^{th} | 21,765 | 14 | 6 | 28,111 | 16^{th} |
| 7^{th} | 21,974 | 3 | 7 | 21,344 | 5^{th} |
| 8^{th} | 22,348 | 15 | 8 | 26,332 | 11^{th} |
| 9^{th} | 24,864 | 20 | 9 | 20,988 | 4^{th} |
| 10^{th} | 25,000 | 4 | 10 | 31,500 | 20^{th} |
| 11^{th} | 26,332 | 8 | 11 | 27,830 | 14^{th} |
| 12^{th} | 26,791 | 16 | 12 | 28,369 | 17^{th} |
| 13^{th} | 27,000 | 2 | 13 | 19,500 | 1st |
| 14^{th} | 27,830 | 11 | 14 | 21,765 | 6^{th} |
| 15^{th} | 27,983 | 18 | 15 | 22,348 | 8^{th} |
| 16^{th} | 28,111 | 6 | 16 | 26,791 | 12^{th} |
| 17^{th} | 28,369 | 12 | 17 | 28,751 | 18^{th} |
| 18^{th} | 28,751 | 17 | 18 | 27,983 | 15^{th} |
| 19^{th} | 29,333 | 5 | 19 | 20,560 | 3^{rd} |
| 20^{th} | 31,500 | 10 | 20 | 24,864 | 9^{th} |
| | 500,000 | | | 500,000 | |

### Example 1.3

### Resolving Ties (as Between the Numbers 1 to 20) within the Ranking List

While the above Example 1.2, Table 1 does not have any ties, it will be inevitable that ties will occur where two or more numbers within the 20 numbers available for selection used in this example are chosen exactly the same number of times by the players in the game. Multiple numbers of ties between numbers could also occur. In this Example 1 of the game, it is preferable that all ties within the Ranking List are resolved.

While there will be a number of ways to resolve ties within the Ranking List, such as by using a random method, the preferred way to resolve all ties in this Example 1 of the use of the game is to use the unpredictability of the results of all the players' choices in the game itself, by using the resulting ‘odds’ and ‘evens’ that arise for each of the 20 numbers—as set out in the column headed “NUMBER OF TIMES CHOSEN” in Example 1.2—Table 1 above (the “Selection Total”).

Referring to Example 1.2—Table 1, it will be apparent that each of the 20 numbers have been chosen a certain number of times and that this results in either an odd numbered Selection Total or an even numbered Selection Total, representing the number of times each of the 20 numbers was chosen. Whether a number to be chosen from within the range of 20 numbers is going to end up being chosen a number of times that is either an odd or even Selection Total number is entirely unpredictable, and is a chance result. This chance result creates a unique method to resolve ties.

In this example, to resolves ties, an even number Selection Total will result in the lowest face value relevant to a tied number being ranked ahead of the higher face valued number. An odd number Selection Total will operate in reverse. For example if the following numbers (2, 13, 18 and 20) were in a four-way tie with the same Selection Total number of, for example, 26,333, which is an odd Selection Total number, then the order of the four tied numbers becomes 20, 18, 13 and 2.

### Example 1.4

### The Elimination Processes—to Determine the Winning Player of the 1^{st} First Phase Game

The First Elimination:

The first elimination process involves reducing the players in the game from 500,000 to a much lower number. This occurs by eliminating all players other than those players that chose number [13] as their first number choice, which is the number that was least picked by all the 500,000 punters in the game as their first number choice, as it was chosen 19,500 times—see Example 1.2—Table 1.

Super Game Entry:

In this example of the game, all players that correctly chose as their first number, the least picked number that became ranked 1^{st} in the Ranking List, being 19,500 players that correctly chose number 13, obtain entry into Super Draw—see Example 1.14.

The Second Elimination:

The second elimination process involves reducing the remaining 19,500 players from 19,500 to a much lower number. This is done by eliminating from the remaining 19,500 players, all players except those that also chose number [1] as their 2^{nd} number choice, which is the number that was the second least picked number by all the 500,000 players in the game, as it was chosen 19,657 times and accordingly is ranked 2^{nd} on the Ranking List—see Example 1.2—Table 1.

Further Eliminations—the Ranking System:

Using similar methods described above, and where relevant, the next best choice made by players by reference to the Ranking List, further eliminations can be made and a first phase game winner/s can always be determined.

When considering Example 1.6, Table 3 below, the 6 number choices of the best 10 performing players (entries) are set out in Example 1.5, Table 2 below:

TABLE 2
Example 1.5 - Top 10 Players' chosen Numbers

| | 1^{st} | 2^{nd} | 3^{rd} | 4^{th} | 5^{th} | 6^{th} |
|---|---|---|---|---|---|---|
| | Number | Number | Number | Number | Number | Number |
| | Choice | Choice | Choice | Choice | Choice | Choice |
| P.1 | 13 | 1 | 19 | 14 | 4 | 10 |
| P.2 | 13 | 1 | 19 | 14 | 8 | 9 |
| P.3 | 13 | 1 | 19 | 14 | 8 | 7 |
| P.4 | 13 | 1 | 19 | 15 | 9 | 3 |
| P.5 | 13 | 1 | 19 | 4 | 2 | 5 |
| P.6 | 13 | 1 | 19 | 4 | 11 | 9 |
| P.7 | 13 | 1 | 19 | 4 | 11 | 7 |
| P.8 | 13 | 1 | 19 | 4 | 10 | 7 |
| P.9 | 13 | 1 | 19 | 8 | 9 | 10 |
| P.10 | 13 | 1 | 19 | 8 | 7 | 9 |

TABLE 3
Example 1.6 - Determining the winning player of the 1^{st} First Phase Game

| | No. of Players | | | | | | | | | | |
|---|---|---|---|---|---|---|---|---|---|---|---|
| | | | | | | | | | | | . . . To |
| | P.1 | P.2 | P.3 | P.4 | P.5 | P.6 | P.7 | P.8 | P.9 | P.10 | P. 500,000 |
| 1^{st} No: [13] | 19,500 | 19,500 | 19,500 | 19,500 | 19,500 | 19,500 | 19,500 | 19,500 | 19,500 | 19,500 | 19,500 |
| (no of times | 1 | 1 | 1 | 1 | 1 | 1 | 1 | 1 | 1 | 1 | |
| chosen by all | | | | | | | | | | | |
| punters in game; | | | | | | | | | | | |
| and ranking) | | | | | | | | | | | |
| 2^{nd} No: [1] | 19,657 | 19,657 | 19,657 | 19,657 | 19,657 | 19,657 | 19,657 | 19,657 | 19,657 | 19,657 | c. 900 |
| | 2 | 2 | 2 | 2 | 2 | 2 | 2 | 2 | 2 | 2 | left |
| 3^{rd} No: [19] | 20,560 | 20,560 | 20,560 | 20,560 | 20,560 | 20,560 | 20,560 | 20,560 | 20,560 | 20,560 | c. 40 |
| | 3 | 3 | 3 | 3 | 3 | 3 | 3 | 3 | 3 | 3 | left |
| 4^{th} No | 21,765 | 21,765 | 21,765 | 22,348 | 25,000 | 25,000 | 25,000 | 25,000 | 26,332 | 26,332 | By |
| | 6 | 6 | 6 | 8 | 10 | 10 | 10 | 10 | 11 | 11 | Rank |
| | | | | (4^{th}) | | | | | | | |
| 5^{th} No | 25,000 | 26,332 | 26,332 | 20,988 | 27,000 | 27,830 | 27,830 | 31,500 | 20,988 | 21,344 | |
| | 10 | 11 | 11 | 4 | 13 | 14 | 14 | 20 | 4 | 5 | |
| | (1^{st}) | | | | (5^{th}) | | | (8^{th}) | (9^{th}) | (10^{th}) | |
| 6^{th} No | 31,500 | 20,988 | 21,344 | 21,974 | 29,333 | 20,988 | 21,344 | 21,344 | 31,500 | 20,988 | |
| | 20 | 4 | 5 | 7 | 19 | 4 | 5 | 5 | 20 | 4 | |
| | | (2^{nd}) | (3^{rd}) | | | (6^{th}) | (7^{th}) | | | | |
| Extra Numbers | . . . | . . . | . . . | . . . | . . . | . . . | . . . | . . . | . . . | . . . | |
| if needed | | | | | | | | | | | |

As can be seen from Example 1.6, Table 3 above, player P.1 is the sole winner.

TABLE 4
Example 1.7
Exampled Prize Winnings for each First Phase
(Weekly) Game - Prizes are 50% of the Entry Price -
And c. 25,000 players obtaining entry into Super Game

| | Approx. | | | |
|---|---|---|---|---|
| | Maximum | | | |
| | Number of | | | |
| | Players in each | | Total | % of $ |
| | stage of each | | Maximum | 2.5m |
| Elimination | First Phase | Prizes per | Amount of | Prize |
| Factors | Game | Ticket | Prizes | Pool |
| | 500,000 | n/a | n/a | n/a |
| (÷20) 1^{st} No. | 25,000 | $10 + | $250,000 | 10.0 |
| | | Super Game | | |
| (÷19) 2^{nd} No. | 1,315 | $200 + | $265,000 | 10.6 |
| | | above | | |
| (÷18) 3^{rd} No. | 73 | $2,000 + | $140,000 | 5.6% |
| | | above | | |
| (÷17) 4^{th} No. | [10] Remaining | $20,000 + | $200,000 | 8.0% |
| | participants other | above | | |
| | than sole winner | | | |
| (÷16) 5^{th} No. | Winner | $1,000,000 + | $1,000,000 | 40.0% |
| | | above | | |
| (÷15) 6^{th} No. | | | | |
| To Last Place | | | $20,000 | 0.8% |
| To Super Race | | | $625,000 | 25.0% |
| Totals | | | $2,500,000 | 100% |

### Example 1.8

### The Odds of Obtaining an Entry into the Super Game

In this Example 1, the odds of obtaining an entry into Super Game—by correctly choosing the number that becomes ranked first on the Ranking List—is 1 in 20.

It will be appreciated that, while the odds of obtaining entry into Super Game are 1 in 20, or 5%, when using the least picked method to determine the first ranked number on the Ranking List, the actual number of qualifying entries into Super Game will be less than 5% in number. This is clear from our Example 1.2 which shows that the first ranked number is number 13, with it being chosen 19,500 times out of 500,000, resulting in 3.9% of players qualifying for the Super Game.

In this example, by using the least picked method, the odds of obtaining a qualifying entry into Super Game is always 1 in 20, but there will always be less than 5% by number of all entries that will qualify.

### Example 1.9

### The “Super Game”

As already set out earlier, and as can be seen from Example 1.7, Table 4 above (last entry), the game includes a Super Game, which receives an allocation of 25% of the weekly prize fund from each of the 25 first phase games, that accumulates for prizes in a later Super Game that is to be run after the conclusion of the first phase games.

The Super Game involves the same identical processes of eliminations and winning as applicable to the weekly/first phase games, and for those players that attain entry, it also involves those players having on their entry, in order 6 randomly allocated numbers out of 20.

The participation by players in the Super Game is only achieved by:
Purchasing a ticket in a first phase game; and
Correctly picking a first ranked number on the Ranking List in a first phase game.

### Random Allocation of Super Game Numbers

The 6 numbers allocated for the Super Game are preferably only allocated to those ‘weekly’ first phase game players that correctly pick the number that becomes the first ranked number on the Ranking List for the relevant week's/first phase game. This random allocation is to ensure that no player can stipulate what numbers he or she wants to choose for the Super Game, thereby ensuring the integrity of the Super Game result.

In addition, to further ensure the integrity of the Super Game result, the 6 Super Game numbers allocated to the relevant players from each week's first phase game are not merged at any time into any combined set of data until after the last first phase game has been played.

### Example 1.10

### Super Game Prizes

The totalizer prizes available for the winner of the Super Game will be significantly higher than the first phase game which may be a weekly game.

Assume that:
the Super Game is conducted at the end of a cycle of 25 first phase games which may be run weekly, for example; and
there are 25 weeks of first phase games, with each first phase game having the same participation and winning profile as described previously; and
the process of winning Super Game is the same as for the first phase games; and
in each of the 25 weeks, $625,000 is set aside from each first phase game—to accumulate for the Super Game; and
Guaranteed Prizes: at the end of the 25 first phase games, there is $15,625,000 available as a ‘guaranteed’ prize pool for Super Game prizes.
Extra Prize: The following extra prize may also be won in Super Game:

| Event | Odds (1 in . . .) | Extra Prize Amount |
|---|---|---|
| First 6 Numbers in | 1 in 27,907,200 | $50,000,000 |
| order out of 20 | | |

Cost to the Gaming Operator of the Extra Prize: The cost to the gaming operator of providing the extra prize of $50 million as set out above, is calculated by us at 1.792% of ALL revenues from each relevant first phase game. It is a cost to the gaming operator. We have calculated this cost based on a third party insurer requiring a premium of 2× the insured risk. (Alternatively this could be self insured by the gaming operator, potentially at a lower cost). This calculation is set out in the table below:

| | | Total | | Ins Cost per | Adjust Ins cost per | Cost as a % |
|---|---|---|---|---|---|---|
| | | Premium | Odds | each Entry in | ALL entries | of each $10 |
| Event | Ins Amt | (2x ins amt) | (1 in . . .) | Super Game | (1/20^{th}) | entry fee |
| 6 in | $50,000,000 | $100,000,000 | 27,907,200 | $3.584 | $0.1792 | 1.792% |
| order | | | | | | |
| Total | | | | | | 1.792% |

TABLE 5
Example 1.11
Exampled Prize Winnings for Super Game of
the ‘Guaranteed’ Prizes (the Totalizer Prizes)

| | | | Total | |
|---|---|---|---|---|
| | Maximum | | Maximum | % of |
| | Number of | | Amount of | $15.625 |
| | Players in | Prizes per | Prizes | million |
| Elimination | each stage | Entry | (at each | Prize |
| Factors | of Super Game | Ticket | stage) | Pool |
| | 25,000 | n/a | n/a | n/a |
| | maximum | | | |
| | players per | | | |
| | week × | | | |
| | 25 weeks = | | | |
| | 625,000 | | | |
| (÷20) 1^{st} No. | 31,250 | $100 | $3,125,000 | 20.00% |
| (÷19) 2^{nd} No. | 1,644 | $1,000 + | $1,640,625 | 10.50% |
| | | above | | |
| (÷18) 3^{rd} No. | 91 | $10,000 + | $906,250 | 5.80% |
| | | above | | |
| (÷17) 4^{th} No. | [4] Remaining | $100,000 + | $400,000 | 2.56% |
| | players other | above | | |
| | than sole | | | |
| | winner | | | |
| (÷16) 5^{th} No. | Winner | $9,375,000 + | $9,375,000 | 60.00% |
| | | above | | |
| (÷15) 6^{th} No. | | | | |
| To Last Place | | | $100,000 | 0.64% |
| To costs of | | | $78,125 | 0.50% |
| running Super | | | | |
| Game/misc | | | | |
| Totals | | | $15,625,000 | 100% |

### Example 1.12

### The Odds of Winning Super Game

The odds of winning a prize in Super Game is dependent on the number of entries a player has in the Super Game—i.e. the number of times a player enters first phase games and correctly chooses the number that becomes the first ranked number in the Ranking List in each weekly game. Once entries in the Super Game are attained, then:

For a player that has only one entry into Super Game, the odds of winning the minor prize in Super Game ($100) is 1 in 20.

The odds of winning first place in Super Game and winning the ‘guaranteed’ first prize that is to be won—based on the assumptions set out in this Example 1 and for the player with only one entry in Super Game—the odds of winning must be no more than 1 in 625,000. (Calculation is 500,000 entries per week×25 weeks÷20=625,000).

A player with 1 entry in Super Game then has odds of at least 1 in 20 of winning any prize. The odds get shorter for each additional entry into Super Game that a player has. A player with 10 entries comprising 10 different first number winning choices has odds of at least 1 in 2 of winning any prize.

If a player has 10 entries into Super Game, the odds must be no more than 1 in 62,500 of winning the ‘guaranteed’ first prize that is to be won in Super Game.

In addition, for those players in Super Game, the odds for each entry of winning the extra insured prize of $50 million payable to an entry that has the winning 6 numbers in order, are odds of 1 in 27,907,200. The winning 6 numbers are those numbers ranked 1^{st} to 6^{th} on the Ranking List.

### Variations

The Invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

The examples and the particular proportions set forth are intended to be illustrative only and are thus non-limiting.

The invention has been described with particular reference to certain embodiments thereof. It will be understood that various modifications can be made to the above-mentioned embodiment without departing from the ambit of the invention. The skilled reader will also understand the concept of what is meant by purposive construction.

It will be clear that there are many variations to the above Example 1. For example:
The game could be altered so that there could be two or more numbers in the Ranking List to be selected in order to increase the chances of a participant gaining entry into the Super Game, although there would be a corresponding cost increase in respect of the cost of the ‘extra’ prize insurance when calculated as a spread cost over all entries in all first phase games.
Changes could be made to the above exampled block of numbers comprising 6 numbers out of 20, to comprise a greater or lesser amount of numbers (e.g. 5 out of 35; or 6 out of 15; or 7 out of 13), with a corresponding increase or decrease to the cost of providing the ‘extra’ prize insurance.
Changes could be made to whether or not the order in which participants choose their numbers was or was not important, and if the order was not important, the number range may need to be increased and the cost of providing the ‘extra’ insurance as a cost spread over all the first phase entries may also increase.
Changes could be made to allow for different ticket pricings. In order to allow for ticket prices of say $2, a change could be made to Example 1 whereby for those participants who want to play but only want to spend $2, then those participants have to pick one additional number from a separate qualifying number range of 1-5. These $2 entry participants purchase their 6 numbers for the cost of $2 but their entries only then qualify for prizes in the main first phase game provided that they first correctly pick the winning number in that additional qualifying number range of 1-5. Consistent with the methods set out herein, the winning number in that additional qualifying number range of 1-5 could be the number that is least picked by those $2 entry participants.
Changes could be made to the Super Game. A change could be made so that each week all the funds accumulated in the Super Game account were able to be won in any weekly first phase game. These Super Game funds would only be able to be won in the event that a player in a weekly/first phase game had correctly chosen, in order, all 6 numbers. In this event the winning first phase player would be paid out the accumulated funds in the Super Game account and the series of first phase games would start afresh.
The game could be configured as a three phase game, with a Super Game operating only in the third phase, or a Super Game operating in each of the second and third phases, with extra prizes as herein described available for some or all of the Super Games.
In the game described in Example 1, the number of first phase games could be altered from 25 weekly games down to say 6 weekly games, then followed by Super Game, without affecting the overall cost of the extra prize insurance offered in the Super Game, which we have calculated at 1.792% of over all ticket sales. Such a variation will not affect the 1.792% cost. This is because the cost of the extra prize insurance is only affected by the number of players that move from a first phase game to the Super Game. In Example 1, this is no more than 1 in 20, so the suggested change does not affect this cost.
Similarly, the game described in Example 1 could be altered to comprise a series of first phase games conducted daily, with the Super Game conducted at the end of a week, or month, without the cost of the extra prize insurance being affected.
And changes could be made to the number of entries from each first phase game that become eligible for entry into Super Game. Such a change would affect the cost of the extra prize insurance. If more than 5% of players were to be allowed to gain entry into the Super Game, the cost of the extra prize insurance when spread over all entries would increase. For example, if 10% of all entries were to gain entry into the Super Game, then the cost of the extra prize insurance would increase from 1.792% to 3.584%, spread over all players' entries as we have described earlier.
Further, other changes could be made to the exampled prize payouts to be made from the totalizer prize fund, including increasing or decreasing the amount to be paid from the first phase games to the Super Game prize fund, without the cost of the extra prize insurance being affected.
Changes could be made to the number of Extra Prizes available in the Super

Game. For example, their could be two extra prizes on offer in Super Game, as exampled in the table below:

| Event | Odds (1 in . . .) | Extra Prize Amount |
|---|---|---|
| First 5 Numbers in | 1 in 1,860,480 | $5,000,000 |
| order out of 20 | | |
| First 6 Numbers in | 1 in 27,907,200 | $50,000,000 |
| order out of 20 | | |

Cost to the Gaming Operator of Two Extra Prizes: If a change was made to offer the above two exampled prizes, then the cost to the gaming operator of providing the two extra prizes as set out above would increase and is calculated by us at 4.48% of ALL revenues from each relevant first phase game. We have calculated this cost based on a third party insurer requiring a premium of 2× the insured risk. (Alternatively this could be self insured by the gaming operator, potentially at a lower cost). This calculation is set out in the table below:

| | | Total | | Ins Cost per | Adjust Ins cost per | Cost as a % |
|---|---|---|---|---|---|---|
| | | Premium | Odds | each Entry in | ALL entries | of each $10 |
| Event | Ins Amt | (2x ins amt) | (1 in . . .) | Super Game | (1/20^{th}) | entry fee |
| 5 in | $5,000,000 | $10,000,000 | 1,860,480 | $5.375 | $0.2687 | 2.687% |
| order | | | | | | |
| 6 in | $50,000,000 | $100,000,000 | 27,907,200 | $3.584 | $0.1792 | 1.792% |
| order | | | | | | |
| Total | | | | | | 4.479% |

Further, changes could be made so that extra insured prizes of a much reduced amount were also on offer in the weekly games, in addition to the extra large prize or prizes on offer in the Super Game.

Finally various other alterations or modifications may be made to the foregoing without departing from the scope of this invention.

### INDUSTRIAL APPLICABILITY

The invention provides a computerised system for operating an insurance system in a lottery. This enables a significant major prize to be offered at an affordable cost.

### Advantages

A ‘substantial additional prize’, at a ‘relatively affordable cost:

The advantage of the invention is that in a two phase game, comprising a series of phase one games leading to a Super Game in phase two, a gaming operator can offer in Super Game a ‘substantial additional prize’—at a ‘relatively affordable cost’ to the participants and to the gaming operator—that ‘may’ be won, in addition to the prizes on offer in Super Game that the gaming system guarantees ‘will’ be won as described hereinbefore.

Significant Headline Prize:

Another advantage of the invention is that the gaming operator can advertise a significant headline prize. In Example 1 we use $50 million. Such a headline prize will be attractive to a gaming operator's existing players, and will be useful in attracting new players. Accordingly, the invention will be of use or assistance for a gaming operator's on-going development of its business.

Can Offer Competitive Game and Prizes Irrespective of Player Numbers:

A further advantage of the invention is that it allows a gaming operator to commence a large prize lottery, on a competitive basis, without the need to have surety of a large player base.

Advantages for Use in a Regional or Worldwide Lottery:

The extra large prize system at a ‘relatively affordable cost’ also has advantages when used in a regional or worldwide lottery, compared with the standard ‘LOTTO’ type lotteries. These advantages are similar to those described above: a regional or worldwide lottery can be launched with a large headline prize, without the gaming operator/s needing to have surety of player numbers; and a large headline prize will be attractive to players, and will attract players to participate in the game.

Flexibility:

Another advantage is that more than one large extra prize can be offered in Super Game, with all extra prizes being able to be offered at a ‘relatively affordable cost’, thereby increasing winnings for players and making the overall game attractive to players.

1-27. (canceled)

28. A computer implemented method comprising a step of operating a gaming system having a computer system to record entries to a game and determining one or more winners of the game, in which the game has an entry fee and is conducted in at least a first phase and a final phase, the first phase consisting of one or more games from which
the number of entries in the or each first phase game is or are reduced substantially so that the number of entries which progress from the first phase game or games to the final phase is substantially less than the number of entries in the first phase game or games, the entries in the final phase which have progressed from the one or more first phase games to the final phase being entered into a final game, which final game includes a final prize which may or may not be won, the entry fee for all first phase entries includes an amount which is allocated to be set aside and or used to fund or to purchase insurance against the winning of the final prize.

29. A computer implemented method as claimed in claim 28 wherein the only way a participant can obtain entry to the final phase game is by entry into the first phase game and becoming one of the entries to progress to the final phase of the game.

30. A computer implemented method as claimed in claim 29 wherein the number of entries which progress from the or each first phase to the final phase is less than 30% of the entries to the first phase game or games.

31. A computer implemented method as claimed in claim 30 wherein the number of entries which progress from the or each first phase to the final phase is less than 10% of the entries to the first phase game or games.

32. A computer implemented method as claimed in claim 30 wherein the number of entries which progress from the or each first phase to the final phase is less than 5% of the entries to the first phase game or games.

33. A computer implemented method as claimed in claim 30 wherein the number of entries which progress from the or each first phase to the final phase is less than 1% of the entries to the first phase game or games.

34. A computer implemented method as claimed in claim 28 wherein the game includes one or more intermediate phases between the first phase and the final phase, the number of entries being further reduced in the or each intermediate phase of the game.

35. A computer implemented method as claimed claim 34 wherein the final phase also includes prizes which must be won.

36. A computer implemented method as claimed claim 35 wherein the first phase includes prizes which may or which must be won.

37. A computerized gaming system having at least one computer system to record entries to a game and determining one or more winners of the game, in which the game has an entry fee and is conducted in at least a first phase and a final phase, the first phase consisting of one or more games from which
the number of entries in the or each first phase game is or are reduced substantially so that the number of entries which progress from the first phase game or games to the final phase is substantially less than the number of entries in the first phase game or games, the entries in the final phase which have progressed from the one or more first phase games to the final phase being entered into a final game, which final game includes a final prize which may or may not be won, the entry fee for all first phase entries includes an amount which is allocated to be set aside and or used to fund or to purchase insurance against the winning of the final prize.

38. A computerized gaming system as claimed in claim 37 wherein the only way a participant can obtain entry to the final phase game is by entry into the first phase game and becoming one of the entries to progress to the final phase of the game.

39. A computerized gaming system as claimed in claim 38 wherein the number of entries which progress from the or each first phase to the final phase is less than 30% of the entries to the first phase game or games.

40. A computerized gaming system as claimed in claim 39 wherein the number of entries which progress from the or each first phase to the final phase is less than 10% of the entries to the first phase game or games.

41. A computerized gaming system as claimed in claim 39 wherein the number of entries which progress from the or each first phase to the final phase is less than 5% of the entries to the first phase game or games.

42. A computerized gaming system as claimed in claim 39 wherein the number of entries which progress from the or each first phase to the final phase is less than 1% of the entries to the first phase game or games.

43. A two-phase game result determination system incorporating a computer system, the computer system including:
one or more first game result determiners able to receive multiple entries to the game,
a final game result determiner able to receive entries permitted by the first game result determiner to move from the or each first game determiner to the final game result determiner, and
one or more data stores capable of recording the entry fee paid for an entry to the first game result determiner,
the first game result determiner or first game result determiners, on receipt of all entries in the game, permitting some entries to proceed to the final game result determiner,
and optionally allocating a prize to at least some of the entries received by the or each first game result determiner;
the second game result determiner, on receipt of the entries from the or each first game result determiner which proceed to the final game result determiner optionally allocating a prize to at least some of the entries which proceeded to the final game result determiner, and
allocating a final prize, which may or may not be won, to one or more of the entries which proceeded to the final game result determiner, the total entry fees paid for all entries recorded by the data stores being in part allocated to fund or purchase insurance against the winning of the final prize.

44. A two-phase game result determination system as claimed in claim 43 wherein the only way a entry can move to the final game result determiner is to be permitted by a first game result determiner to progress to the final game result determiner.

45. A two-phase game result determination system as claimed in claim 44 wherein the number of entries which progress from the or each first game result determiner to the final game result determiner is less than 10% of the entries to the first game result determiner or first game result determiners.

46. A two-phase game result determination system as claimed in claim 45 wherein the number of entries which progress from the or each first game result determiner to the final game result determiner is less than 5% of the entries to the first game result determiner or first game result determiners.

47. A two-phase game result determination system as claimed in claim 45 wherein the number of entries which progress from the or each first game result determiner to the final game result determiner is less than 1% of the entries to the first game result determiner or first game result determiners.
